(19) United States
(12) Patent Application Publication
(10) Pub. No.: US 2004/0162024 A1
(43) Pub. Date: Aug. 19, 2004

(54) Embedding class of service information in MAC control frames

(76) Inventor: Maarten Menzo Wentink, Utrecht (NL)

Correspondence Address: DEMONT & BREYER, LLC, SUITE 250, 100 COMMONS WAY, HOLMDEL, NJ, 07733, US

(21) Appl. No.: 10/377,323

(22) Filed: Feb. 28, 2003

Related U.S. Application Data
(60) Provisional application No. 60/447,512, filed on Feb. 14, 2003.

(51) Int. Cl. H04Q 7/00

(52) U.S. Cl. 455/41.2; 455/435.1; 370/338

(57) ABSTRACT

An apparatus for improving the compilation of quality of service information in wireless local area networks is disclosed. In the illustrative embodiment, a class-of-service field is embedded in medium access control (MAC) control frames; this field is populated with an indication of the class of service of a Data Frame associated with the control frame.

### REFERENCE TO RELATED APPLICATIONS

This application claims the benefit of:

1. U.S. Provisional Patent Application Ser. No. 60/443661, filed on 14 Feb. 2003, Attorney Docket 680-022us, entitled “Priority Distribution in MAC Control Frames,”

which is also incorporated by reference.

The following U.S. patent applications are incorporated by reference:

2. U.S. patent application Ser. No. 10/______, filed on 28 Feb. 2003, Attorney Docket 680-053us, entitled “Transmit Power Management in Shared-Channel Communications Networks,” and

3. U.S. patent application Ser. No. 10/353,391, filed on 29 Jan. 2003, Attorney Docket 680-032us, entitled “Direct Link Protocol in Wireless Area Networks.”

### FIELD OF THE INVENTION

The present invention relates to telecommunications in general, and, more particularly, to a technique for power management in networks that communicate via a shared-communications channel.

### BACKGROUND OF THE INVENTION

FIG. 1 depicts a schematic diagram of an IEEE 802.11-compliant wireless local area network, which comprises: station 101-1, station 101-2, which is an access point, and station 101-3. The communications between station 101-1, station 101-2, and station 101-3 occur within a shared-communications channel, and, therefore, a medium access control protocol is used to allocate usage of the channel among the stations.

In accordance with the IEEE 802.11 standard, one medium access control protocol used by the stations is carrier sense multiple access. In accordance with carrier sense multiple access, a station desiring to transmit a frame first listens to the channel and transmits only when it fails to sense another transmission.

For the purposes of this specification, the “potency” of a transmitted frame is defined as the effective spatial reach of the transmitted frame. As is well-known to those skilled in the art, the potency of a frame can be adjusted by the transmitter and is affected by the energy per bit at which the frame is transmitted. When, as in FIG. 1, each station is within the transmission range of every other station, carrier sense multiple access works well. In contrast, when every station is not within transmission range of every other station, as in FIG. 2, carrier sense multiple access might not work as well. For example, when station 201-1 transmits a Frame, station 201-3 will not sense it, and, therefore, might begin a transmission that prevents station 201-2 from correctly receiving either transmission. This is known as the “hidden” node problem.

The IEEE 802.11 standard addresses the hidden node problem with a mechanism known as Request-to-Send/Clear-to-Send. The message flow associated with the Request-to-Send/Clear-to-Send mechanism is depicted in FIG. 3.

In accordance with the Request-to-Send/Clear-to-Send mechanism, station 201-1 sends a Request-to-Send Frame at time t₀ to all of the stations within its transmission range (i.e., station 201-2). The Request-to-Send Frame contains a duration value that extends through the duration of the Clear-to-Send Frame and any Data and Acknowledgement Frames that station 201-1 expects will be transmitted as part of its request. All of the stations within the transmission range of station 201-1 receive and decode the Request-to-Send Frame to recover the value in the duration field. The value in the duration field is then used to populate a timer, called the Network Allocation Vector, which indicates how long those stations are to refrain from transmitting, regardless of whether they sense a transmission in the channel or not.

In response to the receipt of the Request-to-Send Frame, station 201-2 transmits a Clear-to-Send Frame at time t₂ to all of the stations within its transmission range (i.e., station 201-1 and station 201-3). The Clear-to-Send Frame contains a duration value that extends through the duration of any Data and Acknowledgement Frames that station 201-1 desires to transmit. All of the stations within the transmission range of station 201-2 receive and decode the Request-to-Send Frame to recover the value in the duration field. The value in the duration field is then used to populate their Network Allocation Vector.

In this way, the Request-to-Send/Clear-to-Send mechanism addresses the hidden node problem by ensuring that station 201-3 will not transmit while station 201-1 is transmitting its Data Frame to station 201-2.

### SUMMARY OF THE INVENTION

The present invention addresses a problem that can occur when two IEEE 802.11 techniques are employed in combination. The first technique involves the fact that the IEEE 802.11(e) standard requires the access point to monitor the transmission of Data Frames in the shared-communications channel. The second technique involves the fact that stations that communicate directly—and not through the access point—can adjust the potency of their frames and thus make it impossible for the access point to monitor their transmissions.

With regard to the monitoring of the class-of-service of transmitted frames, the IEEE 802.11(e) standard specifies that a Data Frame can be transmitted from one station to another in accordance with a specified class of service. Furthermore, the standard specifies that the Data Frame comprises a field that is populated with a 3-bit class-of-service code that indicates the class of service of the Data Frame. And still furthermore, the standard specifies that whether the Data Frame is transmitted directly to its destination—in accordance with the direct-link protocol, for example—or indirectly to its destination via the access point, the access point is responsible for monitoring the Data Frames transmitted in the shared-communications channel and for compiling statistics based on the Data Frames transmitted in each class of service. In summary, the IEEE 802.11(e) standard requires the access point to monitor the transmission of Data Frames in the shared-communications channel.

With regard to the fact that stations can make it impossible for the access point to monitor their transmissions, some IEEE 802.11 compliant stations transmit their frames at a fixed level of potency. In contrast, some IEEE 802.11 compliant stations (e.g., 802.11(h) compliant stations, etc.) can adjust the potency of their transmitted frames. The stations that can adjust the potency of their transmitted frames are advantageous because they can conserve energy in contrast to stations that cannot adjust the potency of their transmitted frames. The conservation of energy is particularly advantageous for battery-powered stations such as notebook computers, personal digital assistants, and digital cameras.

In general, the stations that can adjust the potency of their transmitted frames must balance two competing goals:

(1) the potency must be sufficient to ensure that the intended recipient of the frame can receive the frame, and

(2) the potency should be as small as possible so as to conserve as much energy as possible.

An unintended and disadvantageous consequence of having a station decrease the potency of its transmitted frames is that it increases the likelihood that a hidden node might exist. In other words, as a station reduces the potency of its transmitted frames, it increases the likelihood that its transmissions will not be sensed by another station, and, therefore, becomes a hidden node.

When one station is transmitting a Data Frame to a second station directly and at lesser potency, the first station might be hidden from the access point. And when the first station is transmitting a Data Frame that comprises the indication of its class-of-service, the access point will not be able to monitor the transmission of the Data Frame. To overcome this problem, the illustrative embodiment incorporates two mechanisms.

First, while the Data Frames are transmitted with lesser potency, one or more of the medium access control (“MAC”) control frames Request-to-Send, Clear-to-Send, and Acknowledgement Frames associated with the Data Frame are transmitted with greater potency.

In accordance with the illustrative embodiment of the present invention, the potency of a transmitted frame is affected by:

i. the energy per bit of the frame, or

ii. the length of the frame, or

iii. any combination of i and ii.

In particular, frames with fewer bits are more potent than frames with more bits because the probability of receiving a frame with a bit error increases with the number of bits in the frame.

Furthermore, in accordance with the illustrative embodiment of the present invention, the energy per bit of a frame is affected by:

i. the radiated average power level, or

ii. the bit rate, or

iii. the coding rate, or

iv. any combination of i, ii, and iii.

It will be clear to those skilled in the art how each of these factors affects the energy per bit of a frame and how each of these factors affects the rate at which the transmitter consumes energy.

Second, one or more of the Request-to-Send, Clear-to-Send, and Acknowledgement Frames comprises a field that is populated with the 3-bit class-of-service code that indicates the class of service of the Data Frame.

Advantageously, all of the Request-to-Send, Clear-to-Send, and Acknowledgement Frames are transmitted with greater potency and comprise the 3-bit class-of-service code that indicates the class of service of the Data Frame. The result is that by transmitting one or more of the control frames with greater potency, the control frame carry class-of-service information about their associated Data Frames to the access point.

Even though the illustrative embodiments cause some or all of the control frames to be transmitted with greater potency than they might otherwise be, many of the embodiments will still consume, on average, less energy than stations that transmit both data and control frames at a fixed level of potency.

Some embodiments of the present invention are useful when an access point relays Data Frames between the source and destination stations, and some embodiments are useful when the access point does not relay Data Frames (e.g., when the stations communicate directly in accordance with the direct link protocol, etc.). Furthermore, some embodiments of the present invention are useful when a single Data Frame is transmitted, and some embodiments are useful when multiple Data Frames are sent, as in the case of a contention free burst.

The illustrative embodiment comprises: a receiver for receiving an acknowledgement frame that comprises a class-of-service field; and a processor for parsing the acknowledgement frame.

### BRIEF DESCRIPTION OF THE DRAWINGS

FIG. 1 depicts a schematic diagram of a local area network in the prior art in which there is no “hidden” node problem.

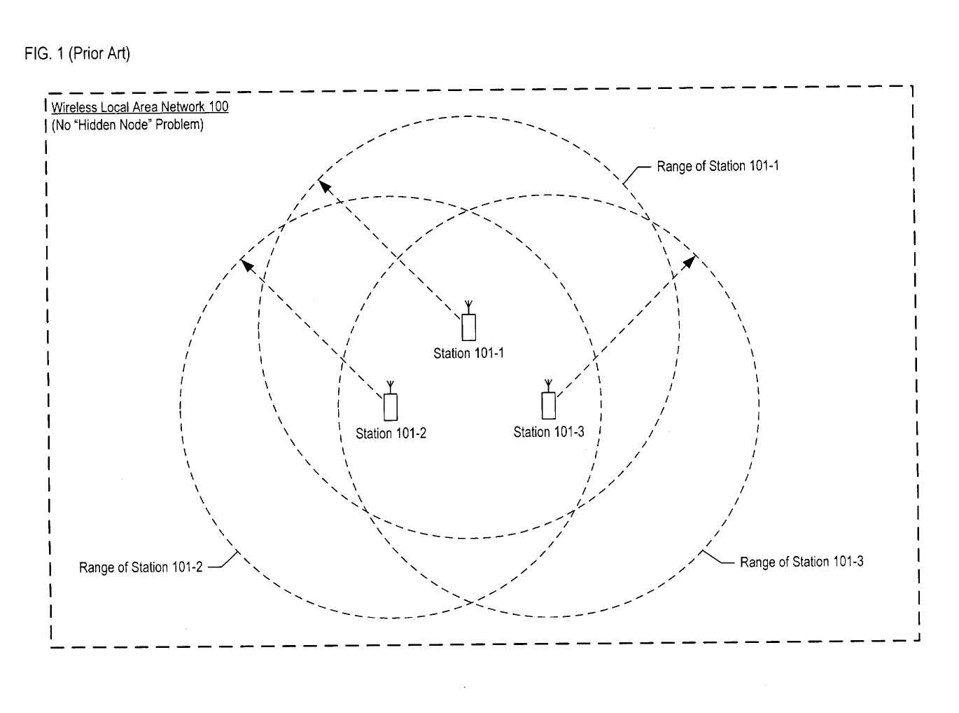

FIG. 2 depicts a schematic diagram of a local area network in the prior art in which there is a hidden node problem.

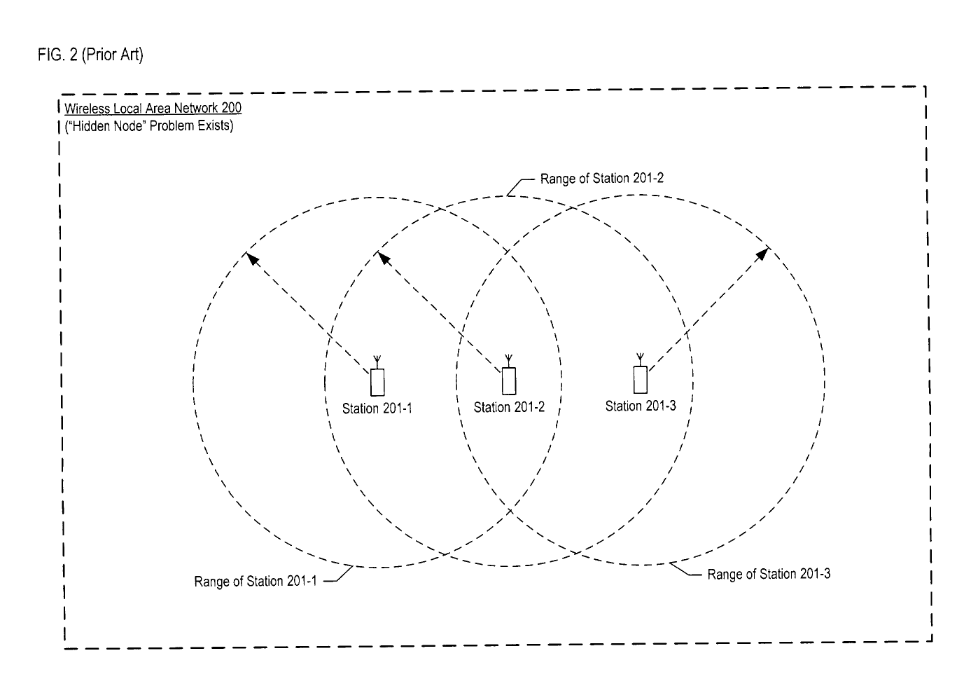

FIG. 3 depicts the message flows associated with the Request-to-Send/Clear-to-Send mechanism for addressing the hidden node problem in FIG. 2.

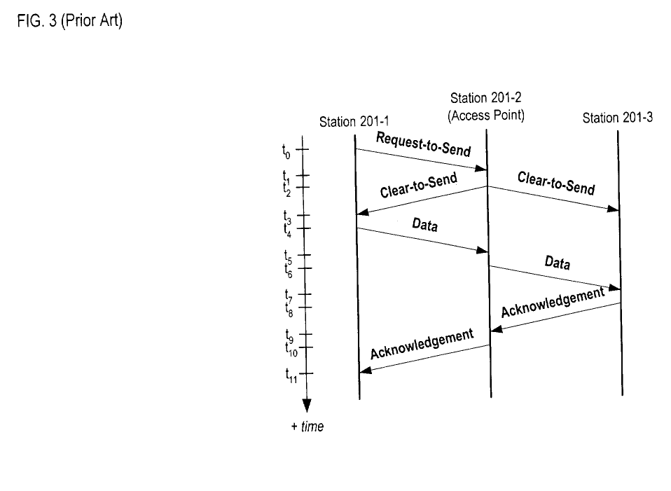

FIG. 4 depicts a schematic diagram of a local area network in accordance with the illustrative embodiments of the present invention.

FIG. 5 depicts a block diagram of the salient components in a station in accordance with the illustrative embodiments of the present invention.

FIG. 6 depicts the message flows associated with the first illustrative embodiment of the present invention.

FIG. 7 depicts the field format of exemplary IEEE 802.11e frame 700, in accordance with the illustrative embodiment of the present invention.

### DETAILED DESCRIPTION

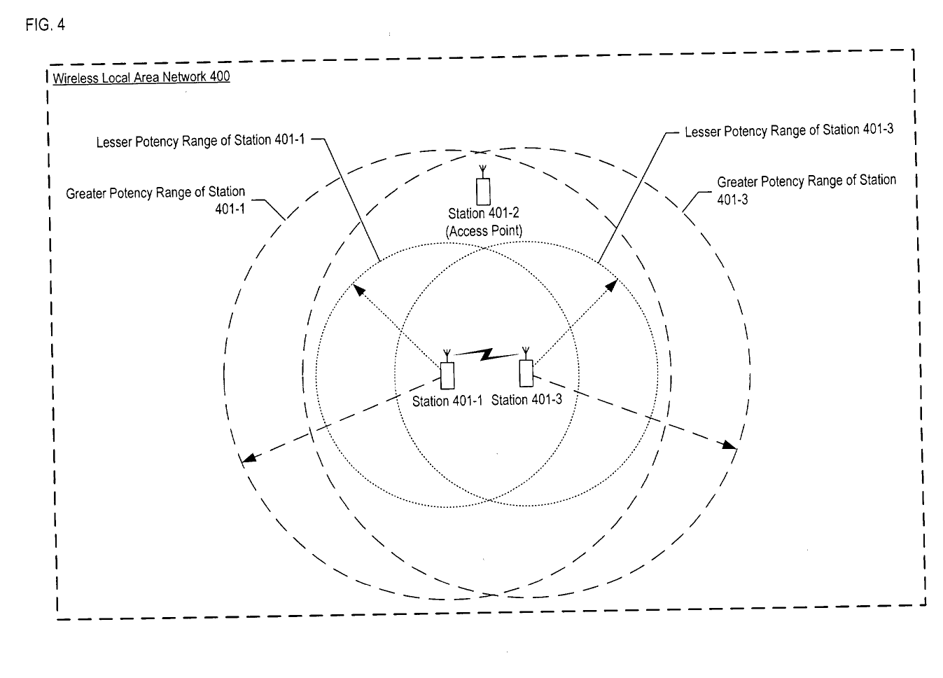

FIG. 4 depicts a schematic diagram of stations 401-1, 401-2, and 401-3, in which station 401-1 transmits a Data Frame to station 401-3 at a first potency and via the direct-link protocol. U.S. patent application Ser. No. 10/353,391, entitled “Direct Link Protocol in Wireless Area Networks,” teaches a direct link protocol. In FIG. 4, station 401-2 is the access point.

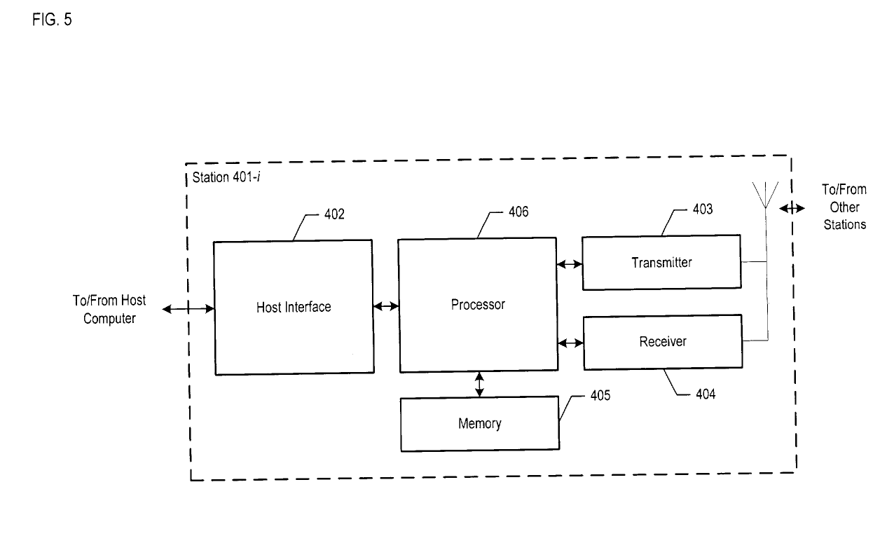

FIG. 5 depicts a block diagram of the salient components of station 401-i, for i=1 to 3, in accordance with illustrative embodiments of the present invention. Station 401-i is one station in an IEEE 802.11-compliant wireless local area network, and, therefore all of the frames are transmitted by all of the stations in the network in compliance with the IEEE 802.11 standard. It will be clear to those skilled in the art, however, after reading this disclosure, how to make and use embodiments of the present invention that operate in a non-IEEE 802.11 compliant network.

Throughout the course of each of the illustrative embodiments, stations 401-1 through 401-4 are deemed to be stationery and the radio frequency environment stable. It will be clear to those skilled in the art, after reading this disclosure, how to make and use embodiments of the present invention that operate in a network in which one or more of the stations move during the course of an atomic operation or in which the radio frequency environment changes during the course of an atomic operation or both.

Station 401-i comprises: processor 406, host interface 402, transmitter 403, receiver 404, and memory 405, interconnected as shown. Station 401-i is fabricated on one or more integrated circuits and interfaces with a host computer (not shown) and an antenna (not shown) in well-known fashion.

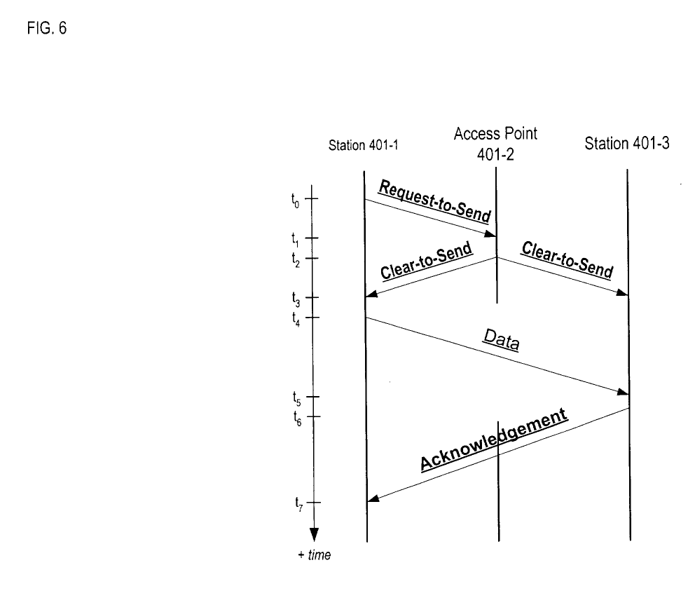

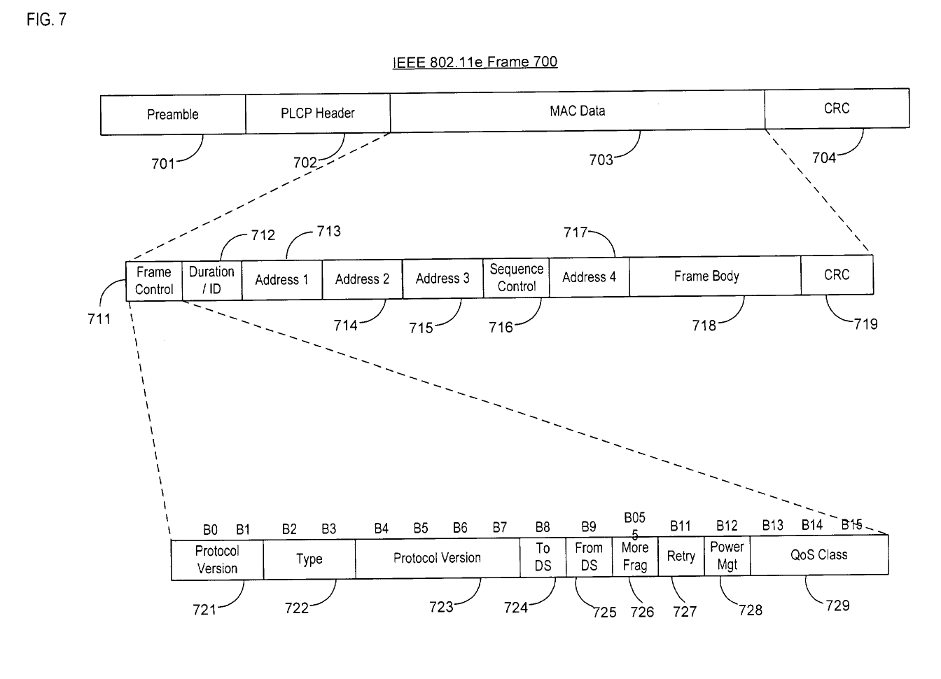

Processor 406 is a general-purpose processor that is capable of executing instructions stored in memory 405, of reading data from and writing data into memory 405, and of executing the tasks described below and with respect to FIGS. 6 and 7. In some alternative embodiments of the present invention, processor 406 is a special-purpose processor. In either case, it will be clear to those skilled in the art, after reading this disclosure, how to make and use processor 406.

Host interface 402 is a circuit that is capable of receiving data and instructions from a host computer (not shown) and of relaying them to processor 406. Furthermore, host interface 402 is capable of receiving data and instructions from processor 406 and relaying them to the host computer. It will be clear to those skilled in the art how to make and use host interface 402.

Transmitter 403 is a hybrid analog and digital circuit that is capable of receiving frames from processor 406 and of transmitting them into the shared-communications channel at times in accordance with IEEE 802.11. It will be clear to those skilled in the art, after reading this disclosure, how to make and use transmitter 403.

Receiver 404 is a hybrid analog and digital circuit that is capable of receiving frames from the shared-communications channel and relaying them to processor 406. It will be clear to those skilled in the art, after reading this disclosure, how to make and use receiver 404.

Memory 405 is a non-volatile random-access memory that stored instructions and data For processor 406. It will be clear to those skilled in the art how to make and use memory 405.

FIG. 6 depicts the message flows for direct-link protocol communication between stations utilizing power management, in accordance with the illustrative embodiment of the present invention.

At time tₒ station 401-1 transmits a Request-to-Send Frame that comprises a field that is populated with a 3-bit code that indicates the class of service of the Data Frames that are associated with the Request-to-Send Frame. The Request-to-Send Frame is transmitted at a second potency that is greater than the first potency and which is indicated in FIG. 6 by the bold formatting of “Request-to-Send.” The Request-to-Send Frame is received by station 401-2 at time t₁. Because the Request-to-Send Frame is transmitted at the greater potency, station 401-2 receives it.

Station 401-2 can decode the Request-to-Send Frame and recover the 3-bit code that indicates the class of service of the Data Frame(s) that are associated with the Request-to-Send Frame. Thereafter, if station 401-2 can't decode the Data Frames, it can still compile statistics on the Data Frames and their class of service.

At time t₂, station 401-2 transmits a Clear-to-Send Frame that comprises a field that is populated with the same 3-bit code that indicates the class of service of the Data Frames. The Clear-to-Send Frame is transmitted at the greater potency as is indicated in FIG. 6 by the bold formatting of “Clear-to-Send. The Clear-to-Send Frame is received at time t₃ by stations 401-1 and 401-3.

Similarly, station 401-2 can decode the Clear-to-Send Frame and recover the 3-bit code that indicates the class of service of the Data Frame(s) that are associated with the Clear-to-Send Frame. Thereafter, if station 401-2 can't decode the Data Frames, it can still compile statistics on the Data Frames and their class of service.

At time t₄, station 401-1 transmits a Data Frame directly to station 401-3 at the lesser potency to reach station 401-3 and is received at station 401-3 at time t₅. As is well-known to those skilled in the art, the Data Frame comprises a field that is populated with the 3-bit class-of-service code that indicates the class of service of the Data Frame.

Because the Data Frame is transmitted with low potency, station 401-2 does not receive the Data Frame with sufficient signal-to-noise ratio to decode it. This is indicated in FIG. 6 by the “disappearance” of the vertical line corresponding to station 401-2 at time interval [t₄, t₅]).

At time t₆, station 401-3 transmits an Acknowledgement Frame that comprises a field that is populated with the 3-bit class-of-service code that indicates the class of service of the previous Data Frame. The Acknowledgement Frame is transmitted with greater potency and is received at station 401-1 and station 401-2 at time t₇.

The result is that although station 401-2 is too far away to receive the Data Frames transmitted from station 401-1 to 401-2, station 401-2 can ascertain the class of service of those Data Frames from the control frames that that it does receive. Although for these purposes the reception by station 401-2 of the Request-to-Send Frame, the Clear-to-Send Frame, and the Acknowledgement Frame(s) is redundant, in some alternative embodiments of the present invention not all of the Request-to-Send Frame, the Clear-to-Send Frame, and the Acknowledgement Frame(s) are transmitted with greater potency.

FIG. 7 depicts the format of IEEE 802.11e control frame (i.e., Request-to-Send, Clear-to-Send, or Acknowledgement Frame) 700 in accordance with the illustrative embodiment of the present invention. As shown in FIG. 7, frame 700 comprises preamble 701, PLCP header 702, MAC data 703, and CRC 704, as are well-known in the art. Preamble 701, PLCP header 702, and CRC 704 are exactly the same as in the IEEE 802.11 specification.

MAC data portion 703 comprises frame control field 711, duration/ID field 712, recipient address field 713, transmitter address field 714, remaining address field 715, sequence control address field 716, wireless distribution system address field 717, frame body 718, and CRC 719, as are well-known in the art. With the exception of frame control field 711, all of the above fields (i.e., 712 through 719) are exactly the same as in the IEEE 802.11 specification.

Frame control field 711 comprises 2-bit protocol version 721, 2-bit type 722, 4-bit protocol version 723, and the following 1-bit flags: to-DS 724, from-DS 725, more-frag 726, retry 727, and power-management 728, as are well-known in the art. A class-of-service field comprising the last three bits of frame control field 711 is populated with a code corresponding to the class-of-service of a Data Frame associated with control frame 700, as disclosed above.

It will be clear to those skilled in the art that in some embodiments the class-of-service might be embedded in only Request-to-Send Frames, only Clear-to-Send Frames, only Acknowledgement Frames, or in any two of these control frames, and that such embodiments provide equivalent functionality to the illustrative embodiment disclosed above in which class-of-service is embedded in all three of these control frames. It will also be clear to those skilled in the art that in some embodiments the class-of-service code might be located in a different portion of frame control field 700 than in the illustrative embodiment disclosed above. Similarly, in some embodiments there might be more than 8 classes of service, in which case the class-of-service code would have more than 3 bits. In addition, although the illustrative embodiment of the present invention is disclosed in the context of IEEE 802.11 wireless networks, and in particular IEEE 802.11e networks, it will be clear to those skilled in the art how to make and use embodiments of the present invention for other kinds of networks and network protocols.

It is to be understood that the above-described embodiments are merely illustrative of the present invention and that many variations of the above-described embodiments can be devised by those skilled in the art without departing from the scope of the invention. It is therefore intended that such variations be included within the scope of the following claims and their equivalents.

What is claimed is:

1. A node in a telecommunications network, said node comprising:
a receiver for receiving an acknowledgement frame that comprises a class-of-service field; and
a processor for parsing said acknowledgement frame.

2. The node of claim 1 wherein said class-of-service field is populated with an indication of the class of service of a Data Frame associated with said acknowledgement frame.

3. The node of claim 2 wherein said processor is also for compiling a traffic metric for said Data Frame's class of service.

4. The node of claim 3 further comprising a carrier sensing mechanism for determining the transmission time of said Data Frame, wherein said transmission time is included in said traffic metric.

5. The node of claim 4 further comprising a transmitter for broadcasting said traffic metric.

6. The node of claim 5 wherein said receiver, said transmitter, and said processor operate in accordance with IEEE 802.11e, and wherein said acknowledgement frame and said Data Frame are in accordance with IEEE 802.11e, and wherein said acknowledgement frame and said Data Frame are transmitted in accordance with a direct link protocol.

7. The node of claim 2 wherein said acknowledgement frame is transmitted with greater potency than potency with which said Data Frame is transmitted.

8. A node in a telecommunications network, said node comprising:
a receiver for receiving a Data Frame that comprises a first class-of-service field, wherein said first class-of-service field is populated with an indication of said Data Frame's class of service; and
a transmitter for transmitting an acknowledgement frame that comprises a second class-of-service field, wherein said second class-of-service field is populated with said indication of said Data Frame's class of service.

9. The node of claim 8 further comprising a processor for parsing said Data Frame and composing said acknowledgement frame.

10. The node of claim 8 wherein said receiver and said transmitter operate in accordance with IEEE 802.11e, and wherein said acknowledgement frame and said Data Frame are in accordance with IEEE 802.11e.

11. The node of claim 10 wherein said acknowledgement frame and said Data Frame are transmitted in accordance with a direct link protocol.

12. The node of claim 8 wherein said acknowledgement frame is transmitted with greater potency than the potency with which said Data Frame is transmitted.

13. The node of claim 8 wherein said transmitter is also for transmitting a second Data Frame at lesser potency than the potency with which said acknowledgement frame is transmitted.

14. A node in a telecommunications network, said node comprising:
a transmitter for transmitting a Data Frame that comprises a first class-of-service field, wherein said first class-of-service field is populated with an indication of said Data Frame's class of service; and
a receiver for receiving an acknowledgement frame that comprises a second class-of-service field, wherein said second class-of-service field is populated with said indication of said Data Frame's class of service.

15. The node of claim 14 further comprising a processor for composing said Data Frame and parsing said acknowledgement frame.

16. The node of claim 14 wherein said receiver and said transmitter operate in accordance with IEEE 802.11e, and wherein said acknowledgement frame and said Data Frame are in accordance with IEEE 802.11e, and wherein said Data Frame and said acknowledgement frame are transmitted in accordance with a direct link protocol.

17. The node of claim 14 wherein said acknowledgement frame is transmitted with greater potency than the potency with which said Data Frame is transmitted, and wherein the average radiated power with which said acknowledgement frame is transmitted is within 50% of the average radiated power with which said Data Frame is transmitted.

18. The node of claim 14 wherein said transmitter is also for transmitting a second acknowledgement frame at greater potency than the potency with which said Data Frame is transmitted.

19. A node in a telecommunications network, said node comprising:
a receiver for receiving a Request-to-Send Frame that comprises a first class-of-service field, wherein said first class-of-service field is populated with an indication of the class of service of a Data Frame associated with said Request-to-Send Frame; and
a transmitter for transmitting a Clear-to-Send frame that comprises a second class-of-service field, wherein said second class-of-service field is populated with said indication of the class of service of said Data Frame.

20. The node of claim 19 wherein:
said Request-to-Send Frame also comprises a duration field populated with an indication of the transmission time of at least one frame, wherein said at least one frame comprises said Data Frame; and
said transmission time is included in a traffic metric for said Data Frame's class of service.
